(19) United States
(12) Patent Application Publication
(10) Pub. No.: US 2022/0055840 A1
(43) Pub. Date: Feb. 24, 2022

(54) Conveyor Roller and Production Method

(71) Applicant: Interroll Holding AG, Sant'Antonino (CH)

(72) Inventor: Jürgen Schumacher, Sant'Antonino (CH)

(21) Appl. No.: 17/312,016

(22) PCT Filed: Dec. 18, 2019
(86) PCT No.: PCT/EP2019/085950

§ 371 Date: Jun. 9, 2021

(30) Foreign Application Priority Data
Dec. 18, 2018 (DE) 10 2018 132 705.6

(51) Int. Cl. B65G 23/08; B65G 39/09; F16F 15/32

(52) U.S. Cl. CPC B65G 23/08; H02K 7/04; F16F 15/32; B65G 39/09

(57) ABSTRACT

The invention relates to a conveyor roller for conveyor systems for conveying containers, pallets, piece goods, and the like. The invention further relates to a method for producing and balancing, in particular dynamic balancing, such a conveyor roller. The conveyor roller comprises a roller body having a roller axle, the outside circumferential surface thereof being a contact surface for conveyed goods or being wrapped about by conveyed goods, and a head element (100), an insertion section (110) thereof being inserted into a hollow end of the roller body, wherein a groove (200) is formed on an end face (120) of the head element (100) facing away from the insertion section (110), in order to receive at least one balancing weight (301-304).

### CROSS REFERENCE TO RELATED APPLICATIONS

This application is the U.S. national stage of International Application No. PCT/EP2019/085950, filed on 2019 Dec. 18. The international application claims the priority of DE 102018132705.6 filed on 2018 Dec. 18; all applications are incorporated by reference herein in their entirety.

### BACKGROUND

The invention relates to a conveyor roller for conveying systems for conveying containers, pallets, piece goods and the like. The invention furthermore relates to a method for producing and for balancing, in particular dynamically balancing, such a conveyor roller.

Conveyor rollers are used for different purposes in logistical applications. Typical areas of application are, for example, mail distribution centers, the food processing industry, assembly lines in the electronics industry, machine chains in automation, manufacturing plants, shipping and packaging lines, picking systems for large pharmaceutical distributors, pallet transport in beverage distribution, cargo handling or cash desks in supermarkets. In this case, the usual practice is to construct a conveying section which consists of a plurality of rollers arranged next to one another, the upper circumferential surface of which rollers in each case serves to receive the conveyed material. Arranged in these conveying sections there are, on the one hand, idling rollers, which are driveless and are merely rotatably supported in a conveyor frame. Also arranged in these conveying sections are driven conveyor rollers, which are motor-driven and are set in rotation by an electric drive unit. The motor-driven conveyor rollers serve, on the one hand, to transport the conveyed goods directly by means of the outer circumferential surface of their roller body. On the other hand, it is also possible, by transmission of the rotation of the motor-driven conveyor roller to one or more idling rollers by means of a transmission element, for example a belt drive, for one or more idling rollers to be set in rotation by the motor-driven conveyor roller in order to drive the conveyed goods via their outer circumferential surfaces too.

Conveyor rollers are preferably constructed in such a way that the roller body is hollow, at least in some section or sections, and in particular has one hollow end, preferably two hollow ends. In the case of motor-driven conveyor rollers, the drive unit is preferably arranged within an interior space of the roller body. If the drive unit is arranged inside the roller body, no mechanical components arranged outside the roller body are required to produce the rotation of the roller. A drive unit arranged in the interior space of the roller body can have, for example, a clutch unit which is designed and arranged to transmit torque from the drive unit to an inner circumferential surface of the interior space of the roller body.

Drum motors of the type mentioned at the outset and their drive units are used in conveying systems, which often have conveyor rollers without an electric drive unit in addition to drum motors. Depending on the application, a conveyor belt, for example a transport belt, a plastic link belt or a modular or module belt, is mounted on the drum motors and/or conveyor rollers. Alternatively, the goods to be transported can also rest directly on the drum motors and/or idling rollers. In order to transport the goods to be transported, one or more conveyor rollers are set in rotation by a drive. For this purpose, the conveyor rollers have a drive unit, wherein such a conveyor roller with a drive unit can also be referred to as a drum motor. Conveyor rollers can also be set in rotation, for example, by a drive belt, which is connected to a drive unit or a drum motor.

Conveyor rollers, in particular drum motors and/or idling rollers, are known, for example, from DE 10 2006 054 575 A1, EP 1 02 1664 B1, DE 20 2009 012 822 U1, DE 10 2015 104 130 or DE 10 2015 114 030 of the applicant.

Especially in the food processing industry, where, for example, dairy products, fish or meat are transported, conveyor rollers must meet the high hygiene requirements in this sector and withstand washing processes involving chemicals and hot water under high pressure. Drive systems with geared motors, such as drum motors, are a potential source of contamination in food processing. Conveyor rollers, in particular drum motors, for use in food processing must therefore be designed and processed in such a way as to reduce the risk of contamination. At the same time, there is often a requirement for low-vibration drives in food processing, particularly in areas of weighing units, and therefore dynamically balanced drum motors are often used. Conveyor rollers, in particular drum motors, should furthermore be economical and efficient.

### SUMMARY

It is therefore an object of the present invention to provide a conveyor roller for conveying systems for conveying containers, pallets, piece goods and the like, a method for producing and a method for balancing, in particular dynamically balancing, such a conveyor roller which are improved over existing solutions. In particular, it is an object of the present invention to provide a conveyor roller for conveying systems for conveying containers, pallets, piece goods and the like, a method for producing and a method for balancing such a conveyor roller which make possible a low-cost and/or reliable and/or process-safe solution, in particular one which is reliable and/or process-safe with regard to hygiene for food safety.

This object is achieved according to the invention by a conveyor roller for conveying systems for conveying containers, pallets, piece goods and the like, comprising a roller body having a roller axis, the outer circumferential surface of which forms a support surface for conveyed goods or is looped around by a conveyor belt, and a head element, an insertion section of which is inserted into a hollow end of the roller body, wherein a groove for receiving at least one balancing weight is formed on an end face of the head element facing away from the insertion section.

### DETAILED DESCRIPTION

The invention is based on the recognition that the balancing, in particular dynamic balancing of conveyor rollers by negative compensation, in which masses are removed by drilling, grinding or milling, can have negative effects on process safety and reliability with regard to food safety since bacterial colonies accumulate preferentially at locations machined in this way.

The term balancing refers to the reduction or elimination of an unbalance and can be performed statically or dynamically. The compensation required for this is generally negative in the case of existing conveyor rollers, in that the material of the head element is removed in the form of bores, notches or surfaces. This results in cavities and, in the process of machining during balancing, there is the risk of through-holes in some cases, which can have a negative effect since they produce an often unwanted connection between the interior of the roller body, in which, for example, a drive unit can be arranged, and the environment.

The conveyor roller described here now provides on the head element a groove designed to receive at least one balancing weight. This makes it possible to positively balance the conveyor roller by arranging at least one balancing weight in the groove.

With such a positive compensation, the at least one balancing weight is applied, e.g. by welding, gluing, clamping or screwing on.

The conveyor roller described here has the advantage that no unwanted passages from the environment to the interior of the roller body due to the removal of material can arise during the balancing process. On the contrary, the groove can be introduced into the head element in a controlled and process-safe manner since this groove can be of identical design for all conveyor rollers and does not depend on the unbalance of an individual conveyor roller. The individual unbalance of a conveyor roller can be compensated by positive compensation, namely the arrangement of at least one balancing weight in the groove. Particularly high hygiene requirements can also be met in various areas of application since reliable separation of the environment from the interior of the roller body and a drive unit arranged therein, for example, can be ensured.

A radial direction is to be understood as meaning a direction orthogonal to the roller axis, and an axial direction is to be understood as meaning a direction parallel to the roller axis.

The conveyor roller described here can be designed as an idling roller or as a motor-driven conveyor roller. In an embodiment as a motor-driven conveyor roller, the conveyor roller is characterized by a drive unit which is designed and arranged to transmit torque to the roller body.

In particular, the conveyor roller described here can have two head elements, which are preferably arranged at opposite hollow ends of the roller body. The two head elements of a conveyor roller can preferably be of substantially the same design and/or, in particular, have the same features, in particular with regard to the groove, balancing weights and/or cover plate described here. The advantages, variant embodiments and embodiment details described here for one head element thus also apply to a second head element.

According to a preferred embodiment, provision is made for the groove to be of annular design. This has the advantage that balancing weights can be arranged at any point in the circumferential direction.

It is furthermore preferred that the groove is arranged coaxially with the roller axis. This facilitates balancing.

In particular, the groove has a groove width in the radial direction and a groove depth in the axial direction. The groove depth is preferably greater than the groove width, in particular at least 1.2 or 1.5 times as great.

It is particularly preferred that the groove is of stepped design. A stepped design can be understood, in particular, to mean a design in which a groove base is a contoured surface.

In a preferred embodiment, provision is made for the groove to have a first groove section and a second groove section, wherein a groove depth of the first groove section is greater than a groove depth of the second groove section.

These configurations of the groove are advantageous, particularly in the case of drum motors with a small diameter, for example diameters of a maximum of 80 mm, in order to have sufficient material thickness at the bearing.

A depth of the first groove section is preferably greater than a width of the first groove section. Furthermore, a depth of the second groove section is preferably greater than a width of the second groove section.

A preferred development is distinguished by the fact that the first groove section is of annular design and/or the second groove section is of annular design. In this way, the first and/or the second groove section are/is available for an arrangement of balancing weights at any desired position in the circumferential direction.

A further preferred development envisages that the second groove section is arranged radially inside the first groove section. The second groove section preferably has a smaller mean radius than the first groove section. The first and the second groove sections are preferably arranged coaxially.

Furthermore, it is preferred that the first groove section is radially adjacent to the second groove section. In particular, it is preferred that a minimum radius of the first groove section corresponds to a maximum radius of the second groove section.

According to a preferred embodiment, provision is made for at least one balancing weight to be arranged in the first groove section and/or for at least one balancing weight to be arranged in the second groove section. By arranging at least one balancing weight in the groove, for example in the first and/or in the second groove section, it is possible to compensate an unbalance of a conveyor roller.

It is particularly preferred to arrange at least two, at least three or more balancing weights in the groove, for example in the first and/or in the second groove section. The type, size, weight, number and position of the balancing weights preferably depend on a balancing result which is determined, for example, in a balancing process.

The advantages, variant embodiments and embodiment details described here for one or at least one balancing weight also apply to at least two, at least three or more balancing weights.

In a further preferred embodiment, provision is made for the at least one balancing weight to be of ring segment-shaped design. With the arrangement of at least two, at least three or more balancing weights, the balancing weights, for example some or all of the balancing weights, can have the same or different lengths in the circumferential direction. By virtue of the ring segment-shaped design of the balancing weights, it is possible in a particularly simple manner to produce balancing weights matched to an individual unbalance.

The at least one balancing weight can preferably be produced by providing a balancing ring which is matched to the groove and dividing the balancing ring into at least two ring segments, one of which is used as balancing weight. In this way, a balancing ring that fits into the groove can be produced simply and inexpensively for each head element. In the balancing process, this balancing ring can be removed and then divided into two or more ring segments. By way of the circumferential length of the ring segments, the balancing weight can be adapted to any unbalance that is present. This eliminates the stocking of different balancing weights. At the same time, process reliability can be increased by providing a balancing ring that fits into the groove since the matching ring has only to be divided in the balancing process, but the precision of fit is already predetermined by the balancing ring.

A further preferred refinement is distinguished by the fact that the at least one balancing weight has a balancing weight width in the radial direction and a balancing weight depth in the axial direction. In the circumferential direction, the at least one balancing weight preferably has a balancing weight length.

Furthermore, provision is preferably made for the balancing weight depth to be greater than the balancing weight width.

In this case, it is particularly preferred that the at least one balancing weight has a first and a second balancing weight section, wherein a balancing weight depth of the first balancing weight section is greater than a balancing weight depth of the second balancing weight section.

It is furthermore preferred that the first balancing weight section is of ring segment-shaped design and/or the second balancing weight section is of ring segment-shaped design. In a preferred embodiment, provision is made for the second balancing weight section to be arranged radially inside the first balancing weight section. Furthermore, it is preferred that the first balancing weight section is radially adjacent to the second balancing weight section. In particular, a mean radius of the first balancing weight section can be greater than a mean radius of the second balancing weight section. A minimum radius of the first balancing weight section preferably corresponds to a maximum radius of the second balancing weight section.

The first and the second balancing weight sections are preferably of integral design. This means, in particular, that the first and second balancing weight sections are not produced as separate elements which are connected later.

A further preferred development envisages that the at least one balancing weight consists of metal or comprises metal. Stainless steel and/or zinc and/or tin and/or tungsten are/is particularly suitable here as metals.

In particular, it is preferred that a depth of the first balancing weight section is greater than a width of the first balancing weight section. Furthermore, it is preferred that a depth of the second balancing weight section is greater than a width of the second balancing weight section. A length of the first and second balancing sections is preferably substantially the same.

A preferred development is distinguished by the fact that the at least one balancing weight is secured in the groove, preferably by an adhesive connection. In particular, it is preferred that the first balancing weight section is secured in the first groove section, preferably by an adhesive connection, and/or that the second balancing weight section is secured in the second groove section, preferably by an adhesive connection. Adhesive is preferably applied to the groove and/or to the balancing weight before the balancing weight is inserted into the groove.

According to a preferred embodiment, provision is made for a balancing weight width to be designed to fit precisely with the groove width, and/or for a width of the first balancing weight section to be designed to fit precisely with a width of the first groove section, and/or for a width of the second balancing weight section to be designed to fit precisely with a width of the second groove section.

Here, a precisely fitting design is understood, in particular, to mean a design which is suitable for a fit. A fit is the dimensional relationship between two parts which are intended to fit together without reworking, in this case, in particular, the groove and the balancing weight. These parts preferably have the same contour at the joint.

In a further preferred embodiment, provision is made for a balancing weight depth to be designed to be less than the groove depth, and/or for a depth of the first balancing weight section to be designed to be less than a depth of the first groove section, and/or for a depth of the second balancing weight section to be designed to be less than a depth of the second groove section. The space in the depth between the balancing weight and the groove can preferably be filled with adhesive.

A further preferred refinement is distinguished by the fact that a cover plate, which covers the groove, is arranged on the end face of the head element. The provision of a cover plate has the advantage that the groove and any balancing weights arranged therein are covered and can thus be protected from contamination. This has advantages particularly for use in areas of application which have particularly high hygiene requirements.

Furthermore, provision is preferably made for the cover plate to be of annular design. This is particularly advantageous for covering an annular groove.

It is particularly preferred here that a depth of the cover plate in the axial direction is many times less than a width of the cover plate in the radial direction. In particular, the cover plate can be designed as an annular disk.

It is furthermore preferred that the cover plate is fluid-tightly connected to the end face of the head element, and/or that a connection of the cover plate to the end face of the head element is sealed. As a result, the conveyor roller can also be used, for example, in areas of application in which there is high-pressure cleaning of the conveying systems.

In a preferred embodiment, provision is made for the cover plate to be connected to the end face of the head element by means of an adhesive connection. The adhesive connection is preferably made by means of a self-adhesive film with which the cover plate is covered on the inside.

A preferred development is distinguished by the fact that the cover plate consists of stainless steel or comprises stainless steel.

A further preferred development is characterized by a drive unit which is designed and arranged to transmit torque to the roller body. This conveyor roller thus represents a drum motor.

According to a preferred embodiment, provision is furthermore made for the insertion section and the end of the roller body each to have a cylindrical cross section.

Further advantageous variant embodiments of the device described above can be obtained by combining the preferred features discussed here.

According to a further aspect of the invention, the object mentioned at the outset is achieved by a head element for a conveyor roller for conveying systems for conveying containers, pallets, piece goods and the like, in particular a conveyor roller described above, the head element comprising an insertion section for insertion into a hollow end of the roller body of a conveyor roller, wherein a groove for receiving at least one balancing weight is formed on an end face of the head element facing away from the insertion section.

According to a further aspect of the invention, the object mentioned at the outset is achieved by a method for producing a conveyor roller for conveying systems for conveying containers, pallets, piece goods and the like, in particular a conveyor roller described above, comprising the following steps: providing a roller body having a roller axis, the outer circumferential surface of which forms a support surface for conveyed goods or is looped around by a conveyor belt, inserting an insertion section of a head element into a hollow end of the roller body, wherein a groove for receiving at least one balancing weight is formed on an end face of the head element facing away from the insertion section.

According to a further aspect of the invention, the object mentioned at the outset is achieved by a method for balancing, in particular dynamically balancing, a conveyor roller for conveying systems for conveying containers, pallets, piece goods and the like, in particular a conveyor roller described above, comprising the following steps: providing a conveyor roller described above, arranging at least one balancing weight in the groove in dependence on a balancing result.

The method described above can be refined by providing a balancing ring and producing the at least one balancing weight by dividing the balancing ring into at least two ring segments.

These further aspects and their refinements have features or method steps which make them particularly suitable for use for a conveyor roller described here and its refinements.

With regard to the advantages, variant embodiments and embodiment details of these further aspects of the invention and refinements thereof, attention is drawn to the preceding description of the corresponding device features.

### BRIEF DESCRIPTION OF THE DRAWINGS

Preferred exemplary embodiments are described by way of example with reference to the attached figures, of which:

FIG. 1: shows a longitudinally sectioned view of a conveyor roller;

FIG. 2: shows a cross section along section plane B-B of the conveyor roller shown in FIG. 1;

FIG. 3: shows an enlarged illustration of the detail X from FIG. 1;

FIG. 4: shows a plan view of the head element from FIG. 1;

FIG. 5: shows a cross section along section plane A-A of the head element illustrated in FIG. 4;

FIG. 6: shows an enlarged illustration of a cross section along section plane B-B of the head element illustrated in FIG. 4;

FIG. 7: shows a plan view of a cover plate;

FIG. 8: shows a side view of the cover plate from FIG. 7;

FIG. 9: shows a schematic flowchart of a method for producing a conveyor roller; and

FIG. 10: shows a schematic flowchart of a method for balancing a conveyor roller.

### DETAILED DESCRIPTION OF THE PREFERRED EMBODIMENTS

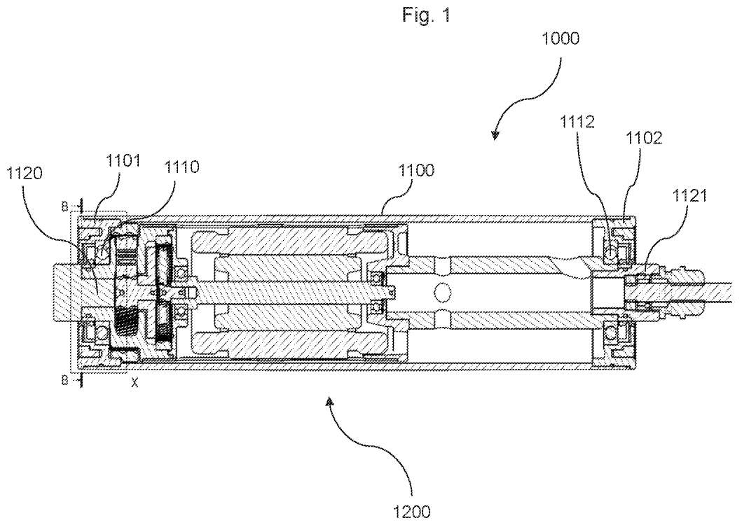

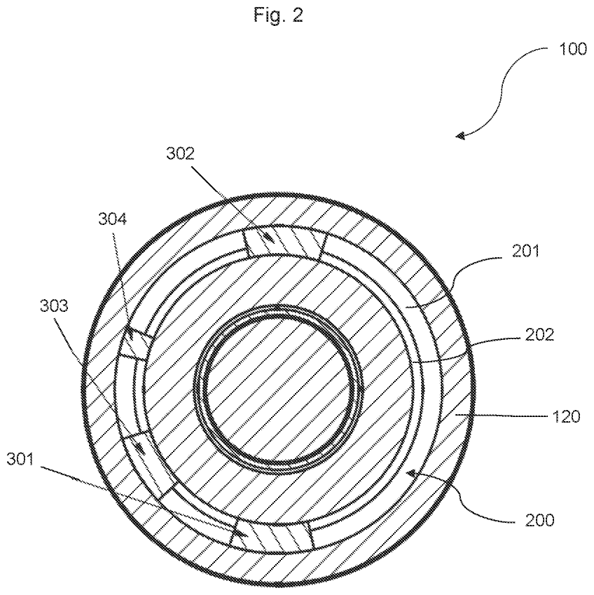

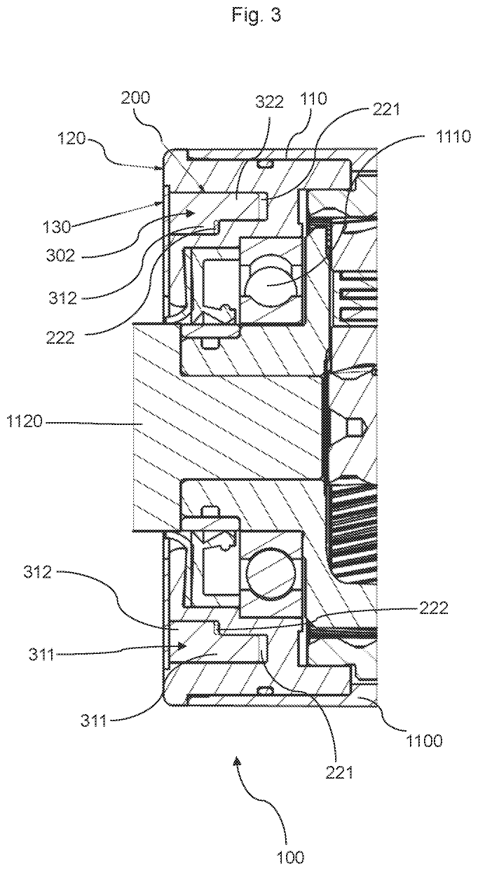

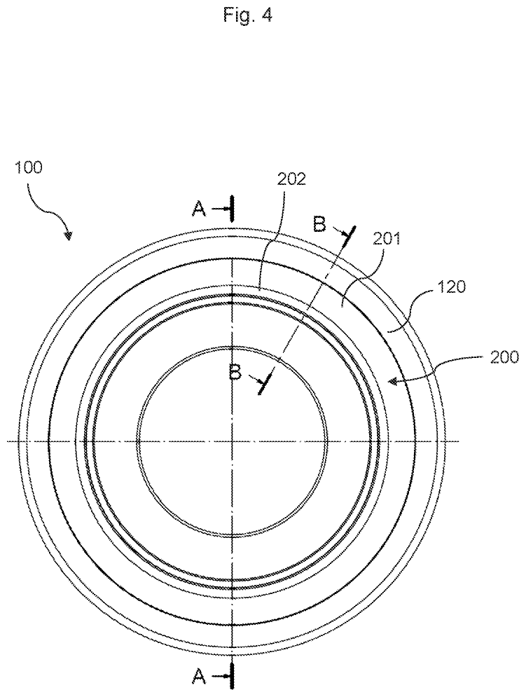

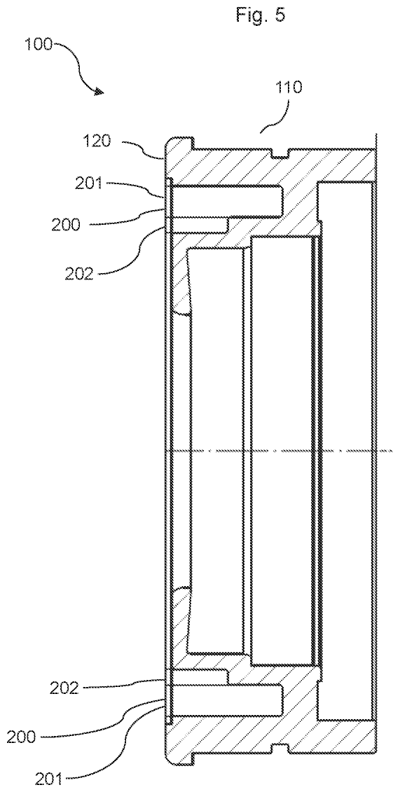

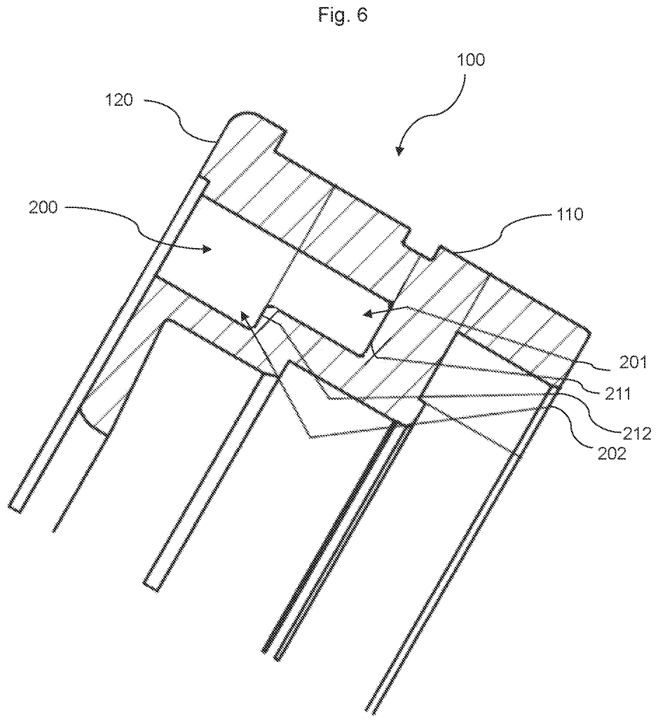

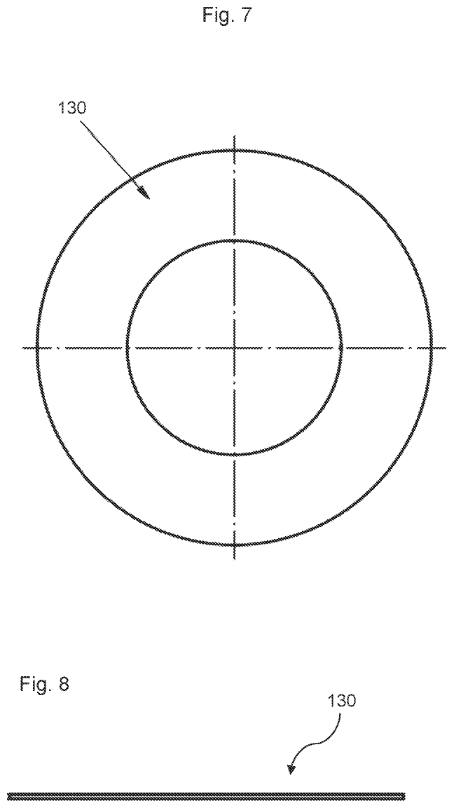

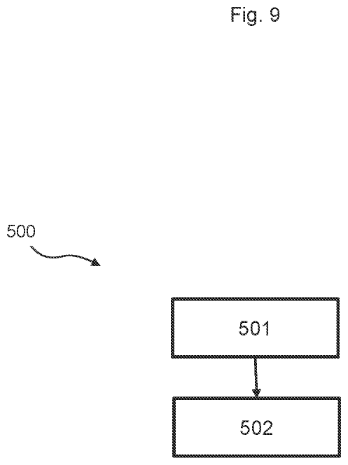

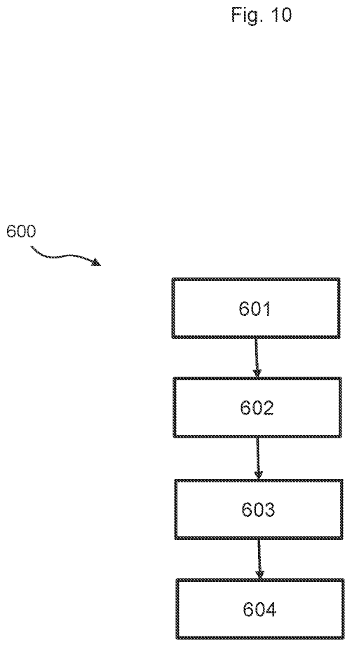

FIG. 1 shows a longitudinally sectioned view of a conveyor roller 1000 having first and second head elements 1101, 1102. In FIGS. 2 to 6, the first head element 1101 is shown in detail as head element 100. FIG. 2 shows a cross section through the head element along section plane B-B of the conveyor roller 1000 illustrated in FIG. 1; FIG. 3 is an enlarged illustration of the detail X from FIG. 1. FIG. 4 shows a plan view of the head element 100 from FIG. 2 without balancing weights. FIG. 5 shows a cross section along section plane A-A of the head element 100 illustrated in FIG. 4, and FIG. 6 shows an enlarged illustration of a cross section along section plane B-B of the head element 100 illustrated in FIG. 4. Finally, FIGS. 7 and 8 show a plan view and a side view of the cover plate 130 of the head element 100. FIGS. 9 and 10 show schematic flowcharts of methods 500, 600 for producing and balancing a conveyor roller 1000.

In the figures, identical or substantially functionally identical elements are provided with the same reference signs. General descriptions generally relate to all embodiments, unless differences are explicitly indicated.

FIG. 1 shows the basic construction of a conveyor roller 1000, which here is designed as a motor-driven conveyor roller. In a roller body 1100, a first head element 1101 is inserted into the roller body 1100 in a torque-proof manner at a first end, and a second head element 1102 is inserted into the roller body 1100 in a torque-proof manner at a second end. Rolling bearings 1110, 1112 are arranged inside the head elements 1101, 1102. The rolling bearings 1110, 1112 serve for the rotatable mounting of bearing journals 1120, 1121. The conveyor roller 1000 can be secured on a frame by means of the bearing journals 1120, 1121.

In FIGS. 2 to 6, the first head element 1101 from FIG. 1 is shown in detail and designated there as head element 100. The second head element 1102 from FIG. 1 is of substantially the same design with respect to the groove, cover plate and balancing weights described in detail below and, in particular, has the same features in this respect. The advantages, variant embodiments and embodiment details described for the first head element thus likewise apply to the second head element.

The head element 100 shown in FIGS. 2 to 6 has an insertion section 110 for insertion into a hollow end of the roller body 1100. The head element 100 preferably comprises plastic or consists of plastic. The outer cylindrical circumference of the insertion section 110 of the head element 100 is preferably the same as or slightly larger than the inner circumference of the hollow end of the roller body 1100, ensuring that frictional engagement occurs when the insertion section 110 is inserted into the hollow end of the roller body 1100.

A groove 200 is formed on an end face 120 of the head element 100 facing away from the insertion section 110. The groove 200 has a groove width in the radial direction and a groove depth in the axial direction. The groove depth is greater than the groove width, in particular at least 1.2 or 1.5 times as great. The groove 200 is of stepped design, wherein the groove base 211, 212 is a contoured surface. The groove 200 has a first groove section 201 and a second groove section 202, wherein the groove depth of the first groove section 201 is greater than the groove depth of the second groove section 202.

Four balancing weights 301, 302, 303, 304 designed as ring segments are arranged in the groove 200 at a spacing in the circumferential direction, as can be seen, in particular, in FIG. 2.

The groove 200 and the first and the second groove sections 201, 202 are arranged coaxially with the roller axis. The groove 200 as well as the first and the second groove sections 201, 202 are furthermore of annular design, which makes it possible to arrange the balancing weights 301, 302, 303, 304 at any desired points in the circumferential direction.

The depth of the first groove section 201 is greater than the width of the first groove section 201. The depth of the second groove section 202 is likewise greater than a width of the second groove section 202. The second groove section 202 is arranged radially inside the first groove section 201 and the second groove section 202 has a smaller mean radius than the first groove section 201. The first groove section 201 is radially adjacent to the second groove section 202, wherein a minimum radius of the first groove section 201 corresponds to a maximum radius of the second groove section 202.

The balancing weights 301, 302, 303, 304 are arranged in the first and second groove sections 201, 202, the type, size, weight, number and positioning of the balancing weights 301, 302, 303, 304 depending on a balancing result determined in a balancing process.

Each of the balancing weights 301, 302, 303, 304 has a balancing weight width in the radial direction, a balancing weight depth in the axial direction and a balancing weight length in the circumferential direction. The balancing weight depth is greater than the balancing weight width.

Each of the balancing weights 301, 302, 303, 304 has a first and a second balancing weight section 311, 312, 321, 322, wherein in each case a balancing weight depth of the first balancing weight section 311, 312 is greater than a balancing weight depth of the second balancing weight section 321, 322.

The respective first and second balancing weight sections are also of ring segment-shaped design, wherein the second balancing weight section 321, 322 is arranged radially inside the first balancing weight section 311, 312, and the first balancing weight section 311, 312 is radially adjacent to the second balancing weight section 321, 322. The mean radius of the first balancing weight section 311, 312 is greater than a mean radius of the second balancing weight section 321, 322, wherein the minimum radius of the first balancing weight section 311, 312 corresponds to the maximum radius of the second balancing weight section 321, 322.

Each of the balancing weights 301, 302, 303, 304, in particular in each case the first and second balancing weight sections 311, 321, 312, 322, is of integral design. This means, in particular, that the respective first and second balancing weight sections 311, 321, 312, 322 are not produced as separate elements which are connected later.

Each of the balancing weights 301, 302, 303, 304 consists of metal, for example stainless steel and/or zinc and/or tin and/or tungsten.

For each of the balancing weights 301, 302, 303, 304, the depth of the first balancing weight section 311, 312 is greater than a width of the first balancing weight section 311, 312, and the depth of the second balancing weight section 321, 322 is greater than a width of the second balancing weight section 321, 322, wherein the length of the first and second balancing sections 311, 321, 312, 322 per balancing weight 301, 302, 303, 304 is substantially the same.

The balancing weights 301, 302, 303, 304 have different lengths in the circumferential direction. By virtue of the ring segment-shaped design of the balancing weights 301, 302, 303, 304, it is possible in a particularly simple manner to produce balancing weights 301, 302, 303, 304 matched to an individual unbalance and to arrange these in the groove 200.

Each of the balancing weights 301, 302, 303, 304 is arranged in the groove 200 and secured there by an adhesive connection, wherein the space 221, 222 is filled with adhesive in the depth between the balancing weight 301, 302, 303, 304 and the groove 200. In this case, both the first balancing weight section 311, 312 in the first groove section 201 and the second balancing weight section 321, 322 in the second groove section 202, are secured by an adhesive connection, wherein adhesive is applied to the groove 200 and/or to the balancing weights 301, 302, 303, 304 before the balancing weights 301, 302, 303, 304 are inserted.

The balancing weight width is designed to fit precisely with the groove width, in particular the width of the first balancing weight section 311, 312 is designed to fit precisely with the width of the first groove section 201, and the width of the second balancing weight section 321, 322 is designed to fit precisely with the width of the second groove section 202. This ensures a fit between the balancing weight 301, 302, 303, 304 and the groove 200.

The balancing weight depth is designed to be less than the groove depth, in particular the depth of the first balancing weight section 311, 312 is less than the depth of the first groove section 201, and the depth of the second balancing weight section 321, 322 is less than the depth of the second groove section 202.

An annular cover plate 130 made of stainless steel is furthermore arranged on the end face 120 of the head element 100. As can be seen, in particular, in FIGS. 3 and 8, the depth of the cover plate 130 in the axial direction is many times less than a width of the cover plate 130 in the radial direction. The cover plate 130 designed as an annular disk covers the groove 200 and the balancing weights 301, 302, 303, 304 located therein. The cover plate 130 is fluid-tightly connected to the end face 120 of the head element 100 by means of an adhesive connection, wherein the connection of the cover plate 130 to the end face 120 of the head element 130 is preferably sealed. Thus, the groove 200 and the balancing weights 301, 302, 303, 304 are protected against contamination, and conveyor roller 1000 can also be used in areas of application which have particularly high hygiene requirements and/or in which there is high-pressure cleaning of the conveying systems.

A conveyor roller 1000 can be produced by providing 501 a roller body 1100 having a roller axis, the outer circumferential surface of which forms a support surface for conveyed goods or is looped around by a conveyor belt, and inserting 502 an insertion section 110 of a head element 100 into the hollow end of the roller body 1100, wherein a groove 200 for receiving at least one balancing weight 301, 302, 303, 304 is formed on an end face 120 of the head element 100 facing away from the insertion section 110. A head element is preferably also inserted on the opposite side of the roller body 1100.

The method 600 for balancing a conveyor roller 1000 may proceed as follows: first, in step 601, a conveyor roller 1000 is provided. The balancing weights 301, 302, 303, 304 are produced, for example, by providing 602 a balancing ring (not shown) which is matched to the groove 200. Depending on the result of the balancing process, the balancing ring is divided in step 603 into at least two ring segments, of which at least one is used as a balancing weight 301, 302, 303, 304 and is arranged in the groove 200 in step 604. For a plurality of balancing weights 301, 302, 303, 304, the steps can be repeated accordingly.

A balancing ring that fits into the groove is preferably produced for each head element and made available for the balancing process. The balancing ring can thus be produced under controlled process conditions with a high precision of fit to the groove. Furthermore, there is no need to stock different balancing weights, but only a need to stock the balancing ring for each head element. In the balancing process, this balancing ring can be removed and then divided into two or more ring segments. By way of the circumferential length of the ring segments, the balancing weight can be adapted to any unbalance that is present.

1. A conveyor roller (1000) for conveying systems for conveying containers, pallets, piece goods, and the like, comprising
a roller body (1100) having a roller axis, the outer circumferential surface of which forms a support surface for conveyed goods or is looped around by a conveyor belt, and
a head element (100), an insertion section (110) of which is inserted into a hollow end of the roller body (1100),
wherein a groove (200) for receiving at least one balancing weight (301, 302, 303, 304) is formed on an end face (120) of the head element facing away from the insertion section (110).

2. The conveyor roller (1000) as claimed in claim 1,
characterized in that the groove (200) is of annular design, and/or
characterized in that the groove (200) is arranged coaxially with the roller axis, and/or
characterized in that the groove (200) has a groove width in the radial direction and a groove depth in the axial direction, and/or
characterized in that the groove depth is greater than the groove width, and/or
characterized in that the groove (200) is of stepped design, and/or
characterized in that the groove (200) has a first groove section and a second groove section (201, 202), wherein a groove depth of the first groove section (201) is greater than a groove depth of the second groove section (202).

3. The conveyor roller (1000) as claimed in claim 1,
characterized in that the first groove section (201) is of annular design and/or the second groove section (202) is of annular design, and/or
characterized in that the second groove section (202) is arranged radially inside the first groove section (201), and/or
characterized in that the first groove section (201) is radially adjacent to the second groove section (202), and/or
characterized in that at least one balancing weight (301, 302, 303, 304) is arranged in the first groove section (201) and/or at least one balancing weight (301, 302, 303, 304) is arranged in the second groove section (202).

4. The conveyor roller (1000) as claimed in claim 1,
characterized in that the at least one balancing weight (301, 302, 303, 304) is of ring segment-shaped design, and/or
characterized in that the at least one balancing weight (301, 302, 303, 304) has a balancing weight width in the radial direction and a balancing weight depth in the axial direction, and/or
characterized in that the balancing weight depth is greater than the balancing weight width, and/or
characterized in that the at least one balancing weight (301, 302, 303, 304) has a first and a second balancing weight section, wherein a balancing weight depth of the first balancing weight section is greater than a balancing weight depth of the second balancing weight section.

5. The conveyor roller (1000) as claimed in claim 1,
characterized in that the first balancing weight section (311, 312) is of ring segment-shaped design and/or the second balancing weight section (321, 322) is of ring segment-shaped design, and/or
characterized in that the second balancing weight section (321, 322) is arranged radially inside the first balancing weight section (311, 312), and/or
characterized in that the first balancing weight section (311, 312) is radially adjacent to the second balancing weight section (321, 322).

6. The conveyor roller (1000) as claimed in claim 1,
characterized in that the at least one balancing weight (301, 302, 303, 304) is secured in the groove (200), preferably by an adhesive connection, and/or
characterized in that the at least one balancing weight (301, 302, 303, 304) consists of metal or comprises metal, and/or
characterized in that the first balancing weight section (311, 312) is secured in the first groove section (201), preferably by an adhesive connection, and/or
characterized in that the second balancing weight section (321, 322) is secured in the second groove section (202), preferably by an adhesive connection.

7. The conveyor roller (1000) as claimed in claim 1,
characterized in that a balancing weight width is designed to fit precisely with the groove width, and/or
characterized in that a balancing weight depth is designed to be less than the groove depth, and/or
characterized in that a width of the first balancing weight section (311, 312) is designed to fit precisely with a width of the first groove section (201), and/or
characterized in that a width of the second balancing weight section (321, 322) is designed to fit precisely with a width of the second groove section (202), and/or
characterized in that a depth of the first balancing weight section (311, 312) is designed to be less than a depth of the first groove section (201), and/or
characterized in that a depth of the second balancing weight section (321, 322) is designed to fit precisely and is less than a depth of the second groove section (202).

8. The conveyor roller (1000) as claimed in claim 1, characterized in that a cover plate (130), which covers the groove (200), is arranged on the end face (120) of the head element.

9. The conveyor roller (1000) as claimed in claim 1,
characterized in that the cover plate (130) is of annular design, and/or
characterized in that a depth of the cover plate (130) in the axial direction is many times less than a width of the cover plate (130) in the radial direction, and/or
characterized in that the cover plate (130) is fluid-tightly connected to the end face (120) of the head element (100), and/or
characterized in that the cover plate (130) is connected to the end face (120) of the head element (100) by means of an adhesive connection, and/or
characterized in that a connection of the cover plate (130) to the end face (120) of the head element (100) is sealed, and/or
characterized in that the cover plate (130) consists of stainless steel or comprises stainless steel.

10. The conveyor roller (1000) as claimed in claim 1,
characterized by a drive unit (1200) which is designed and arranged to transmit torque to the roller body (1100).

11. The conveyor roller (1000) as claimed in claim 1,
characterized in that the insertion section (110) and the end of the roller body (1100) each have a cylindrical cross section.

12. A head element for a conveyor roller (1000) for conveying systems for conveying containers, pallets, piece goods and the like, in particular a conveyor roller (1000) as claimed in claim 1, the head element (100) comprising an insertion section (110) for insertion into a hollow end of the roller body (1100) of a conveyor roller (1000), wherein a groove (200) for receiving at least one balancing weight (301, 302, 303, 304) is formed on an end face (120) of the head element (100) facing away from the insertion section (110).

13. A method (500) for producing a conveyor roller (1000) for conveying systems for conveying containers, pallets, piece goods and the like, in particular a conveyor roller (1000) as claimed in claim 1,
comprising the following steps:
providing a roller body (1100) having a roller axis, the outer circumferential surface of which forms a support surface for conveyed goods or is looped around by a conveyor belt,
inserting an insertion section (110) of a head element (100) into a hollow end of the roller body (1100), wherein a groove (200) for receiving at least one balancing weight (301, 302, 303, 304) is formed on an end face (120) of the head element (100) facing away from the insertion section (110).

14. A method (600) for balancing, in particular dynamically balancing, a conveyor roller (1000) for conveying systems for conveying containers, pallets, piece goods and the like, in particular a conveyor roller (1000) as claimed in claim 1,
comprising the following steps:
providing a conveyor roller (1000) as claimed in claim 1,
arranging at least one balancing weight (301, 302, 303, 304) in the groove (200) in dependence on a balancing result.

15. The method (600) as claimed in claim 14,
characterized by:
providing a balancing ring,
producing the at least one balancing weight (301, 302, 303, 304) by dividing the balancing ring into at least two ring segments.

16. The conveyor roller (1000) as claimed in claim 1,
wherein the at least one balancing weight (301, 302, 303, 304) is secured in the groove (200), wherein the groove (200) is of annular design, wherein a cover plate (130), which covers the groove (200), is arranged on the end face (120) of the head element, the cover plate (130) is of annular design and the cover plate is fluid-tightly connected to the end face (120) of the head element (100).
